(19) United States
(12) Patent Application Publication
(10) Pub. No.: US 2003/0175390 A1
(43) Pub. Date: Sep. 18, 2003

(54) Patch bag having one continuous patch

(76) Inventor: Timothy Theodore Oberle, Varese (IT)

Correspondence Address: Rupert B. Hurley Jr., Cryovac, Inc., P.O. Box 464, Duncan, SC, 29334, US

(21) Appl. No.: 10/389,311

(22) Filed: Mar. 14, 2003

Related U.S. Application Data
(63) Continuation of application No. 08/579,712, filed on Dec. 28, 1995, now abandoned.

(51) Int. Cl. A23B 4/00

(52) U.S. Cl. 426/129

(57) ABSTRACT

A patch bag has a continuous patch adhered to a first lay-flat side of a bag. The continuous patch is in an region of the bag which has one side of the bag not covered by the patch. The continuous patch extends from one end of the bag to the other end of the bag, and/or from one lay-flat side of the bag to the other lay-flat side of the bag. The continuous patch covers a region of the bag in which the bag film is sealed to itself. Optionally, the second lay-flat side of the bag may have a second patch adhered thereto. The second patch does not cover the region of the bag in which the bag film is sealed to itself. In this manner, the patch bag can be produced by adhering the patches to the bag film and thereafter sealing the bag film to itself, in order to form the bag without having to produce the seal by transmitting heat through one or more patches. The patch bag is especially useful in the packaging of a bone-in meat product, especially ham, sparerib, picnic, back rib, short loin, short rib, whole turkey, pork loin.

### FIELD OF THE INVENTION

The present invention relates to patch bags, particularly patch bags used in the packaging of bone-in meat products. Such patch bags have a protective patch adhered directly thereto, the protective patch preventing of bone puncture, or reducing the likelihood of bone puncture.

### BACKGROUND OF THE INVENTION

Bags having patches adhered thereto have for some time been used in the packaging of various bone-in meat products. The patches provide additional resistance to puncture of the bag by the bone in the meat product. In this manner, fewer “leakers” result, and the possibility of meat contamination is also reduced. A variety of patch bags have been used for the packaging of a variety of meat products. Most of the patch bags have been end-seal patch bags having one or two patches adhered to the outside surface of the bag. Generally, the patches do not extend down to the end seal, as the seal would then have to be made through the patch.

The process of manufacturing patch bags has been carried out by adhering the patch or patches to a tubing which is thereafter converted to a bag. In instances in which a two-patch bag is being made, i.e., wherein one patch is adhered to each side of the lay-flat tubing, it has been necessary to “index” the locations of the patches with respect to one another, in order to maintain uncovered regions through which the heat seals can be made. Thereafter, the tubing having patches adhered thereto has been converted to an end-seal bag by making a first transverse cut (i.e., cut across the tubing) at a location above the patch, in order to form the top of the bag. Then a heat seal is made below the patch in order to form the bottom of the bag, with the tubing then being transversely cut below the heat seal, in order to form the bottom edge of the patch bag.

Although it is desirable to have the patches cover as much of the bag as possible, there is a need to leave a small uncovered region above the heat seal which forms the bag bottom, in order to produce the patch bag without having to make the heat seal through patch material. Sealing through patch material has been found to require more production time and more heat, to cause burn-through of the patch material, and to result in weaker seals, compared with processes in which the heat seal is formed by sealing only through the tubing which forms the bag portion of the patch bag. In order to keep the uncovered regions to a minimum, patch bags having a patch on each side have had the patches indexed with respect to one another.

It would be desirable to provide a patch bag having less uncovered area above the heat seal, and it would be even more desirable to do so without having to seal through patch material, without resulting in burn through, and while producing seals which are as strong as are obtained by sealing only through the bag tubing. For patch bags having a patch on each lay-flat side thereof, it would be desirable to avoid the need to precisely index the placement of the patches relative to one another.

### SUMMARY OF THE INVENTION

The present invention provides a patch bag having a patch which extends to and past the seal, without having to form a seal through patch material. In this manner, the puncture-resistance of the bag is increased by increasing the patch coverage. Moreover, the patch bag of the present invention can be made while avoiding: (a) patch material burn-through; (b) the need for more heat to seal through patch material and the accompanying loss of production speed when more heat is required; (c) the production of weaker seals due to sealing through patch material; (d) the need for indexing patches relative to one another; while (e) decreasing the amount of uncovered bag in the proximity of the seal.

As a first aspect, the present invention is directed to a patch bag comprising a bag and a first patch adhered to a first lay-flat side of the bag. The first patch has a length of at least the length of the bag, and no portion of a second lay-flat side of the bag is adhered to a second patch. In the patch bag, preferably the bag comprises a first heat shrinkable film (preferably, biaxially oriented) and the patch comprises a second heat-shrinkable film (preferably, biaxially oriented). Preferably, the bag is an end-seal bag.

Preferably, the first heat shrinkable film comprises an outside abuse layer, a core O₂-barrier layer, and an inside sealant layer. Preferably, the outside abuse layer comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer. Preferably, the core O₂-barrier layer of the bag comprises at least one member selected from the group consisting of ethylene/vinyl alcohol copolymer, polyvinyl chloride, polyvinylidene chloride, polyamide, polyester, polyacrylonitrile. Preferably, the inside sealant layer comprises at least one member selected from the group consisting of thermoplastic polyolefin, thermoplastic polyamide, thermoplastic polyester, and thermoplastic polyvinyl chloride. Preferably, the second heat shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer; more preferably, the second heat-shrinkable film is biaxially-oriented and comprises linear low density polyethylene and ethylene/vinyl acetate copolymer.

As a second aspect, the present invention is directed to a patch bag comprising a bag, a first patch, and a second patch. The first patch is adhered to a first lay-flat side of the bag, and has a length of at least the length of the bag. The second patch is adhered to a second lay-flat side of the bag, and has a length less than the length of the bag. The patch bag further comprises a seal, wherein at least a portion of the seal is in a region not covered by the second patch.

Preferably, the entire seal is in a region not covered by the second patch. Preferably, the bag comprises a first heat shrinkable film, the first patch comprises a second heat-shrinkable film, and the second patch comprises a third heat-shrinkable film. Preferably, each of the first, second, and third heat shrinkable films is a multilayer film. Preferably, the first heat-shrinkable film comprises an outside abuse layer, a core O₂-barrier layer, and an inside sealant layer. Preferably, the outside abuse layer comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer.

Preferably, the core O₂-barrier layer comprises at least one member selected from the group consisting of ethylene/vinyl alcohol copolymer, polyvinyl chloride, polyvinylidene chloride, polyamide, polyester, polyacrylonitrile. Preferably, the inside sealant layer comprises at least one member selected from the group consisting of thermoplastic polyolefin, thermoplastic polyamide, thermoplastic polyester, and thermoplastic polyvinyl chloride.

Preferably, the second biaxially-oriented, heat-shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer. Preferably, the third biaxially-oriented, heat-shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer. More preferably, the second biaxially-oriented, heat-shrinkable film comprises linear low density polyethylene and ethylene/vinyl acetate copolymer, and the third biaxially-oriented, heat-shrinkable film comprises linear low density polyethylene and ethylene/vinyl acetate copolymer.

The patch bag can be an end-seal patch bag or a side-seal patch bag. If the patch bag is an end-seal patch bag, the first patch can have a width greater than a lay-flat width of the tubing, with the first patch having a first overhang region over a first side edge of the bag, and a second overhang region over a second side edge of the bag. The second patch can also have a width greater than a lay-flat width of the tubing, and have a third overhang region over the first side edge of the bag, and a fourth overhang region over the second side edge of the bag. Preferably, the first overhang region adheres to the third overhang region, and the second overhang region adheres to the fourth overhang region. Preferably, the first patch has a length equal to a length of the bag. Preferably, the second patch does not extend to the top of the bag, and does not extend to the bag end seal.

If this patch bag is a side-seal patch bag, the first patch can extend below a bottom edge of the bag, and have a first overhang region over the end of the bag. The second patch also can also extend below the bottom edge of the bag, and have a second overhang region over the end of the bag. The first overhang region can be in adhering relation to the second overhang region.

As a third aspect, the present invention pertains to a packaged product, comprising a package and a meat product in the package. The package comprises a patch bag, which, in turn, comprises a first patch and a second patch. The first patch is adhered to a first lay-flat side of the bag, and the first patch has a length of at least the length of the bag. The second patch is adhered to a second lay-flat side of the bag, and the second patch has a length less than the length of the bag. The patch bag further comprises a seal. The seal is in a region not covered by the second patch. The meat product comprises bone. Preferably, the meat product comprises at least one member selected from the group consisting of ham, sparerib, picnic, back rib, short loin, short rib, whole turkey, and pork loin. The meat product can comprise two bone-in pork loins.

### BRIEF DESCRIPTION OF THE DRAWINGS

FIG. 1 illustrates a schematic view of a preferred end-seal patch bag according to the present invention, in a lay-flat view.

FIG. 2 illustrates a transverse cross-sectional view of the end-seal patch bag illustrated in FIG. 1, taken through section 2-2 of FIG. 1.

FIG. 3 illustrates a longitudinal cross-sectional view of the end-seal patch bag illustrated in FIG. 1, taken through section 3-3 of FIG. 1.

FIG. 4 illustrates a cross-sectional view of a preferred multilayer film suitable for use as the patch in the patch-bag according to FIG. 1.

FIG. 5 illustrates a schematic view of a preferred process for making the multilayer film of FIG. 4.

FIG. 6 illustrates a cross-sectional view of a preferred multilayer film suitable for use as the bag in the patch-bag according to FIG. 1.

FIG. 7 illustrates a schematic view of a preferred process for making the multilayer film of FIG. 6.

FIG. 8 illustrates a schematic view of a preferred process for making the patch bag of FIG. 1, using the films of FIGS. 4 and 6, as respectively produced by the processes of FIGS. 5 and 7, respectively.

### DETAILED DESCRIPTION OF THE INVENTION

As used herein, the phrase “continuous patch” refers to a patch which is adhered to the bag across the entire bag length of an end-seal bag, when the end-seal bag is in its lay-flat position, or a patch which extends across the entire width of a side-seal bag, when the side-seal bag is in its lay-flat position.

As used herein, the phrase “discontinuous patch” refers to a patch which is adhered to the bag across less than the entire bag length of an end-seal bag, when the end-seal bag is in its lay-flat position; or a patch which extends across less than the entire width of a side-seal bag, when the side-seal bag is in its lay-flat position.

As used herein, the phrase “bag length” refers to the length of the bag in the machine direction. Thus, the bag length of end-seal bags runs from the edge of the bag at the open top end of the bag, through to the bottom bag edge below the end seal. For side-seal bags, the bag length runs from a first bag side edge to a second bag side edge.

As used herein, the phrase “bag width” refers to the size, i.e., length, of the bag in the transverse direction (i.e., transverse to the machine direction). Thus, the bag width of an end-seal bag runs from the first bag side edge to the second bag side edge, and the bag width of a side-seal bag runs from edge of the bag at the open top end of the bag, through to the bottom bag edge below the end seal.

As used herein, the phrase “uncovered portion of the bag” refers to a portion of the bag which is not covered by a patch, i.e., a portion of the bag having both its inside surface and its outside surface not adhered to, or otherwise covered by, one or more patches.

As used herein, the phrase “patch overhang region”, or “overhang”, refers to that portion of a patch which extends beyond: (a) a side edge of the bag to which the patch is adhered, or (b) a bottom edge of the bag to which the patch is adhered, when the bag is in a lay-flat configuration, i.e., when the factory seal(s) is flat against a surface on which the bag has been placed.

The “factory seal” includes any and all seals necessary to convert a film tubing or flat film into a bag having an open top. Such seals are made at the bag-making factory, and hence are herein termed to be “factory seals”.

The bag “edge”, or “sideline”, or “bottomline”, beyond which a patch may overhang, is usually formed by a mere “fold” in the bag. Although the bag need not have a crease at its edges, in reality the side edges of end seal bags are creased by processing rollers in the manufacture of the tubing and bags, as is the bottom edge of side-seal bags. However, the edge, sideline, or bottomline also includes bag side and bottom edges which are relatively small regions (i.e., 0.05 inches to either side of the “line”) extending from a seal through both the patch and the underlying bag. Bag edges, sidelines, and bottomlines are determined by placing an empty bag on a flat supporting surface, with the factory seals flat against the supporting surface. The perimeter of the bag in its lay-flat configuration determines the edges, sidelines, and bottomline.

As used herein, the term “film” is used in a generic sense to include plastic web, regardless of whether it is film or sheet. Preferably, films of and used in the present invention have a thickness of 0.25 mm or less. As used herein, the term “package” refers to packaging materials used in the packaging of a product.

As used herein, the phrases “seal layer”, “sealing layer”, “heat seal layer”, and “sealant layer”, refer to an outer film layer, or layers, involved in the sealing of the film to itself, another film layer of the same or another film, and/or another article which is not a film. It should also be recognized that in general, up to the outer 3 mils of a film can be involved in the sealing of the film to itself or another layer. With respect to packages having only fin-type seals, as opposed to lap-type seals, the phrase “sealant layer” generally refers to the inside film layer of a package, as well as supporting layers adjacent this sealant layer, the inside layer frequently also serving as a food contact layer in the packaging of foods. In general, a sealant layer to be sealed by heat-sealing can comprise any thermoplastic polymer; preferably, the heat-sealing layer comprises, for example, thermoplastic polyolefin, thermoplastic polyamide, thermoplastic polyester, and thermoplastic polyvinyl chloride; more preferably, thermoplastic polyolefin; still more preferably, thermoplastic polyolefin having less than 60 weight percent crystallinity. Preferred sealant compositions are the same as the compositions for the abuse layer, as set forth below.

As used herein, the term “seal” refers to any seal of a first region of a film surface to a second region of a film surface, wherein the seal is formed by heating the regions to at least their respective seal initiation temperatures. The heating can be performed by any one or more of a wide variety of manners, such as using a heated bar, hot air, infrared radiation, ultrasonic sealing, etc.

As used herein, the term “barrier”, and the phrase “barrier layer”, as applied to films and/or film layers, is used with reference to the ability of a film or film layer to serve as a barrier to one or more gases. Oxygen (i.e., O₂) barrier layers can comprise, for example, ethylene/vinyl alcohol copolymer, polyvinyl chloride, polyvinylidene chloride, polyamide, polyester, polyacrylonitrile, etc., as known to those of skill in the art; preferably, the oxygen barrier layer comprises ethylene/vinyl alcohol copolymer, polyvinyl chloride, polyvinylidene chloride, and polyamide; more preferably, vinylidene chloride/methyl acrylate copolymer, as known to those of skill in the art.

As used herein, the phrase “abuse layer”, as well as the phrase “puncture-resistant layer”, refer to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal; preferably, abuse layers comprise polymer comprising at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer, etc. as known to those of skill in the art; more preferably, ethylene/vinyl acetate copolymer and ethylene/alpha-olefin copolymer having a density of from about 0.91 to 0.93; still more preferably, the abuse layer of the bag film comprises 85-100 weight percent ethylene/vinyl acetate copolymer, and 0-15 weight percent LLDPE, while the still more preferred abuse layer of the patch film comprises 85-100 weight percent LLDPE and 0-15 weight percent ethylene/vinyl acetate copolymer having a vinyl acetate content of about 9 percent.

As used herein, the term “core”, and the phrase “core layer”, as applied to multilayer films, refer to any internal film layer which has a primary function other than serving as an adhesive or compatibilizer for adhering two layers to one another. Usually, the core layer or layers provide the multilayer film with a desired level of strength, i.e., modulus, and/or optics, and/or added abuse resistance, and/or specific impermeability.

As used herein, the phrase “skin layer” refers to an outside layer of a multilayer film in packaging a product, this skin layer being subject to abuse. Accordingly, the preferred polymers for the skin layer are the same as the preferred polymers for the abuse layer.

As used herein, the phrase “tie layer” refers to any internal layer having the primary purpose of adhering two layers to one another. Tie layers can comprise any polymer having a polar group grafted thereon, so that the polymer is capable of covalent bonding to polar polymers such as polyamide and ethylene/vinyl alcohol copolymer; preferably, tie layers comprise at least one member selected from the group consisting of polyolefin, modified polyolefin, ethylene/vinyl acetate copolymer, modified ethylene/vinyl acetate copolymer, and homogeneous ethylene/alpha-olefin copolymer; more preferably, tie layers comprise at least one member selected from the group consisting of anhydride modified grafted linear low density polyethylene, anhydride grafted low density polyethylene, homogeneous ethylene/alpha-olefin copolymer, and anhydride grafted ethylene/vinyl acetate copolymer.

As used herein, the phrase “bulk layer” refers to any layer of a film which is present for the purpose of increasing the abuse-resistance, toughness, modulus, etc.; of a multilayer film. Bulk layers generally comprise polymers which are inexpensive relative to other polymers in the film which provide some specific purpose unrelated to abuse-resistance, modulus, etc. Preferably, bulk layers comprise polyolefin; more preferably, at least one member selected from the group consisting of ethylene/alpha-olefin copolymer, ethylene/alpha-olefin copolymer plastomer, low density polyethylene, and linear low density polyethylene.

As used herein, “EVOH” refers to ethylene/vinyl alcohol copolymer. EVOH includes saponified or hydrolyzed ethylene/vinyl acetate copolymers, and refers to a vinyl alcohol copolymer having an ethylene comonomer, and prepared by, for example, hydrolysis of vinyl acetate copolymers, or by chemical reactions with polyvinyl alcohol. The degree of hydrolysis is preferably at least 50% and more preferably at least 85%.

As used herein, the term “lamination”, the term “laminate”, and the phrase “laminated film”, refer to the process, and resulting product, made by bonding together two or more layers of film or other materials. Lamination can be accomplished by joining layers with adhesives, joining with heat and pressure, and even spread coating and extrusion coating. The term laminate is also inclusive of coextruded multilayer films comprising one or more tie layers.

As used herein, the term “oriented” refers to a polymer-containing material which has been stretched at an elevated temperature (the orientation temperature), followed by being “set” in the stretched configuration by cooling the material while substantially retaining the stretched dimensions. Upon subsequently heating unrestrained, unannealed, oriented polymer-containing material to its orientation temperature, heat shrinkage is produced almost to the original unstretched, i.e., pre-oriented dimensions.

More particularly, the term “oriented”, as used herein, refers to oriented films, wherein the orientation can be produced in one or more of a variety of manners.

As used herein, the phrase “orientation ratio” refers to the multiplication product of the extent to which the plastic film material is expanded in several directions, usually two directions perpendicular to one another. Expansion in the machine direction is herein referred to as “drawing”, whereas expansion in the transverse direction is herein referred to as “stretching”. A film which is produced by both drawing and stretching is referred to as a “biaxially oriented” film. For films extruded through an annular die, stretching is obtained by “blowing” the film to produce a bubble. For such films, drawing is obtained by passing the film through two sets of powered nip rolls, with the downstream set having a higher surface speed than the upstream set, with the resulting draw ratio being the surface speed of the downstream set of nip rolls divided by the surface speed of the upstream set of nip rolls. The degree of orientation is also referred to as the orientation ratio, or sometimes as the “racking ratio”.

As used herein, the term “monomer” refers to a relatively simple compound, usually containing carbon and of low molecular weight, which can react to form a polymer by combining with itself or with other similar molecules or compounds.

As used herein, the term “comonomer” refers to a monomer which is copolymerized with at least one different monomer in a copolymerization reaction, the result of which is a copolymer.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith.

As used herein, the term “homopolymer” is used with reference to a polymer resulting from the polymerization of a single monomer, i.e., a polymer consisting essentially of a single type of repeating unit.

As used herein, the term “copolymer” refers to polymers formed by the polymerization reaction of at least two different monomers. For example, the term “copolymer” includes the copolymerization reaction product of ethylene and an alpha-olefin, such as 1-hexene. However, the term “copolymer” is also inclusive of, for example, the copolymerization of a mixture of ethylene, propylene, 1-hexene, and 1-octene.

As used herein, the term “polymerization” is inclusive of homopolymerizations, copolymerizations, terpolymerizations, etc., and includes all types of copolymerizations such as random, graft, block, etc. In general, the polymers in the films used in accordance with the present invention, can be prepared in accordance with any suitable polymerization process, including slurry polymerization, gas phase polymerization, and high pressure polymerization processes.

As used herein, the term “copolymerization” refers to the simultaneous polymerization of two or more monomers.

As used herein, a copolymer identified in terms of a plurality of monomers, e.g., “propylene/ethylene copolymer”, refers to a copolymer in which either monomer may copolymerize in a higher weight or molar percent than the other monomer or monomers. However, the first listed monomer preferably polymerizes in a higher weight percent than the second listed monomer, and, for copolymers which are terpolymers, quadripolymers, etc., preferably the first monomer copolymerizes in a higher weight percent than the second monomer, and the second monomer copolymerizes in a higher weight percent than the third monomer, etc.

As used herein, copolymers are identified, i.e, named, in terms of the monomers from which the copolymers are produced. For example, the phrase “propylene/ethylene copolymer” refers to a copolymer produced by the copolymerization of both propylene and ethylene, with or without additional comonomer(s). A copolymer comprises recurring “polymerization units” derived from the monomers from which the copolymer is produced.

As used herein, terminology employing a “/” with respect to the chemical identity of a copolymer (e.g., “an ethylene/alpha-olefin copolymer”), identifies the comonomers which are copolymerized to produce the copolymer. As used herein, “ethylene alpha-olefin copolymer” is the equivalent of “ethylene/alpha-olefin copolymer.”.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous polymers are useful in various layers of the film used in the present invention. Although there are a few exceptions (such as TAFMER (TM) ethylene/alpha-olefin copolymers produced by Mitsui Petrochemical Corporation), heterogeneous polymers typically contain a relatively wide variety of chain lengths and comonomer percentages.

As used herein, the phrase “heterogeneous catalyst” refers to a catalyst suitable for use in the polymerization of heterogeneous polymers, as defined above. Heterogeneous catalysts are comprised of several kinds of active sites which differ in Lewis acidity and steric environment. Ziegler-Natta catalysts are heterogeneous catalysts. Examples of Ziegler-Natta heterogeneous systems include metal halides activated by an organometallic co-catalyst, such as titanium chloride, optionally containing magnesium chloride, complexed to trialkyl aluminum, as is disclosed in patents such as U.S. Pat. No. 4,302,565, to GOEKE, et. al., and U.S. Pat. No. 4,302,566, to KAROL, et. al., both of which are hereby incorporated, in their entireties, by reference thereto.

As used herein, the phrase “homogeneous polymer” refers to polymerization reaction products of relatively narrow molecular weight distribution and relatively narrow composition distribution. Homogeneous polymers are useful in various layers of the multilayer film used in the present invention. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts.

More particularly, homogeneous ethylene/alpha-olefin copolymers may be characterized by one or more methods known to those of skill in the art, such as molecular weight distribution (M_{w}/Mₙ), composition distribution breadth index (CDBI), and narrow melting point range and single melt point behavior. The molecular weight distribution (M_{w}/Mₙ), also known as polydispersity, may be determined by gel permeation chromatography. Homogeneous ethylene/alpha-olefin copolymer generally has (M_{w}/Mₙ) of less than 2.7; preferably from about 1.9 to 2.5; more preferably, from about 1.9 to 2.3.

The composition distribution breadth index (CDBI) of such homogeneous ethylene/alpha-olefin copolymer are generally greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI determination clearly distinguishes homogeneous copolymer (narrow composition distribution as assessed by CDBI values generally above 70%) from VLDPE, which has a broad composition distribution as assessed by CDBI values generally less than 55%. The CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p.441 (1982). Preferably, the homogeneous ethylene/alpha-olefin copolymers have a CDBI greater than about 70%, i.e., a CDBI of from about 70% to 99%. In general, homogeneous ethylene/alpha-olefin copolymer also exhibits a relatively narrow melting point range, in comparison with “heterogeneous copolymer”, i.e., polymer having a CDBI of less than 55%. Homogeneous ethylene/alpha-olefin copolymer can exhibits an essentially singular melting point characteristic, with a peak melting point (Tₘ), as determined by Differential Scanning Colorimetry (DSC), of from about 60° C. to 110° C. Preferred homogeneous copolymer has a DSC peak Tₘ of from about 80° C. to 100° C. As used herein, the phrase “essentially single melting point” means that at least about 80%, by weight, of the material corresponds to a single Tₘ peak at a temperature within the range of from about 60° C. to 110° C., and essentially no substantial fraction of the material has a peak melting point in excess of about 115° C., as determined by DSC analysis. DSC measurements are made on a Perkin Elmer System 7 Thermal Analysis System. Melting information reported are second melting data, i.e., the sample is heated at a programmed rate of 10° C./min. to a temperature below its critical range. The sample is then reheated (2nd melting) at a programmed rate of 10° C./min. The presence of higher melting peaks is detrimental to film properties such as haze, and compromises the chances for meaningful reduction in the seal initiation temperature of the final film.

A homogeneous ethylene/alpha-olefin copolymer can, in general, be prepared by the copolymerization of ethylene and any one or more alpha-olefin. Preferably, the alpha-olefin is a C₃-C₂₀ alpha-monoolefin, more preferably, a C4-C₁₂ alpha-monoolefin, still more preferably, a C4-C8 alpha-monoolefin. Still more preferably, the alpha-olefin comprises at least one member selected from the group consisting of butene-1, hexene-1, and octene-1, i.e., 1-butene, 1-hexene, and 1-octene, respectively. Yet still more preferably, the alpha-olefin comprises octene-1, and/or a blend of hexene-1 and butene-1.

Processes for preparing and using homogeneous polymers are disclosed in U.S. Pat. No. 5,206,075, to Hodgson, U.S. Pat. No. 5,241,031, to Mehta, each of which is hereby incorporated by reference thereto, in its respective entirety. Further details regarding the production and use of homogeneous ethylene/alpha-olefin copolymers are disclosed in PCT International Publication Number WO 90/03414, to Exxon Chemical Patents, Inc, and PCT International Publication Number WO 93/03093, to Meka et al., each of which designates Exxon Chemical Patents, Inc. as the Applicant, and each of which are hereby incorporated by reference thereto, in their respective entireties. Still another genus of homogeneous ethylene/alpha-olefin copolymers is disclosed in U.S. Pat. No. 5,272,236, to LAI, et. al., and U.S. Pat. No. 5,278,272, to LAI, et. al., each of which is hereby incorporated by reference thereto, in its respective entirety.

As used herein, the term “polyolefin” refers to any polymerized olefin, which can be linear, branched, cyclic, aliphatic, aromatic, substituted, or unsubstituted. More specifically, included in the term polyolefin are homopolymers of olefin, copolymers of olefin, copolymers of an olefin and an non-olefinic comonomer copolymerizable with the olefin, such as vinyl monomers, modified polymers thereof, and the like. Specific examples include polyethylene homopolymer, polypropylene homopolymer, polybutene, ethylene/alpha-olefin copolymer, propylene/alpha-olefin copolymer, butene/alpha-olefin copolymer, ethylene/vinyl acetate copolymer, ethylene/ethyl acrylate copolymer, ethylene/butyl acrylate copolymer, ethylene/methyl acrylate copolymer, ethylene/acrylic acid copolymer, ethylene/methacrylic acid copolymer, modified polyolefin resin, ionomer resin, polymethylpentene, etc. Modified polyolefin resin is inclusive of modified polymer prepared by copolymerizing the homopolymer of the olefin or copolymer thereof with an unsaturated carboxylic acid, e.g., maleic acid, fumaric acid or the like, or a derivative thereof such as the anhydride, ester or metal salt or the like. It could also be obtained by incorporating into the olefin homopolymer or copolymer, an unsaturated carboxylic acid, e.g., maleic acid, fumaric acid or the like, or a derivative thereof such as the anhydride, ester or metal salt or the like.

As used herein, terms identifying polymers, such as “polyamide”, “polyester”, “polyurethane”, etc. are inclusive of not only polymers comprising repeating units derived from monomers known to polymerize to form a polymer of the named type, but are also inclusive of comonomers, derivatives, etc. which can copolymerize with monomers known to polymerize to produce the named polymer. For example, the term “polyamide” encompasses both polymers comprising repeating units derived from monomers, such as caprolactam, which polymerize to form a polyamide, as well as copolymers derived from the copolymerization of caprolactam with a comonomer which when polymerized alone does not result in the formation of a polyamide. Furthermore, terms identifying polymers are also inclusive of mixtures, blends, etc. of such polymers with other polymers of a different type.

As used herein, the phrase “ethylene alpha-olefin copolymer”, and “ethylene/alpha-olefin copolymer”, refer to such heterogeneous materials as linear low density polyethylene (LLDPE), and very low and ultra low density polyethylene (VLDPE and ULDPE); and homogeneous polymers such as metallocene catalyzed polymers such as EXACT (TM) resins obtainable from the Exxon Chemical Company, and TAFMER (TM) resins obtainable from the Mitsui Petrochemical Corporation. All these materials generally include copolymers of ethylene with one or more comonomers selected from C₄ to C₁₀ alpha-olefin such as butene-1 (i.e., 1-butene), hexene-1, octene-1, etc. in which the molecules of the copolymers comprise long chains with relatively few side chain branches or cross-linked structures. This molecular structure is to be contrasted with conventional low or medium density polyethylenes which are more highly branched than their respective counterparts. The heterogeneous ethylene/alpha-olefin commonly known as LLDPE has a density usually in the range of from about 0.91 grams per cubic centimeter to about 0.94 grams per cubic centimeter. Other ethylene/alpha-olefin copolymers, such as substantially linear homogeneous long chain branched ethylene/alpha-olefin copolymers available from the Dow Chemical Company, known as AFFINITY (TM) resins, are also included as another type of homogeneous ethylene alpha-olefin copolymer which can be used in the patch bag of the present invention.

In general, the ethylene/alpha-olefin copolymer comprises a copolymer resulting from the copolymerization of from about 80 to 99 weight percent ethylene and from 1 to 20 weight percent alpha-olefin. Preferably, the ethylene/alpha-olefin copolymer comprises a copolymer resulting from the copolymerization of from about 85 to 95 weight percent ethylene and from 5 to 15 weight percent alpha-olefin.

As used herein, the phrases “inner layer” and “internal layer” refer to any layer, of a multilayer film, having both of its principal surfaces directly adhered to another layer of the film.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces are adhered to another layer of the film.

As used herein, the phrase “inside layer” refers to the outer layer, of a multilayer film packaging a product, which is closest to the product, relative to the other layers of the multilayer film. The phrase “inside layer” is also used with respect to various structures, such as tubing, bags, casings, etc, in which the outer film layer which is inside with respect to the tubing, bag, casing, etc structure.

As used herein, the phrase “outside layer” refers to the outer layer, of a multilayer film packaging a product, which is furthest from the product relative to the other layers of the multilayer film. The phrase “outside layer” is also used with respect to various structures, such as tubing, bags, casings, etc, in which the outer film layer which is the outside film layer with respect to the tubing, bag, casing, etc structure.

As used herein, the term “adhered” is inclusive of films which are directly adhered to one another using a heat seal or other means, as well as films which are adhered to one another using an adhesive which is between the two films.

As used herein, the phrase “directly adhered”, as applied to film layers, is defined as adhesion of a subject film layer to an object film layer, without a tie layer, adhesive, or other layer therebetween. In contrast, as used herein, the word “between”, as applied to a film layer expressed as being between two other specified layers, includes both direct adherence of the subject layer between to the two other layers it is between, as well as including a lack of direct adherence to either or both of the two other layers the subject layer is between, i.e., one or more additional layers can be present between the subject layer and one or more of the layers the subject layer is between.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is fed into a rotating screw of variable pitch, i.e., an extruder, which forces the polymeric material through the die.

As used herein, the term “coextrusion” refers to the process of extruding two or more materials through a single die with two or more orifices arranged so that the extrudates merge and weld together into a laminar structure before chilling, i.e., quenching. Coextrusion can be employed in film blowing, free film extrusion, and extrusion coating processes.

As used herein, the phrase “machine direction”, herein abbreviated “MD”, refers to a direction “along the length” of the film, i.e., in the direction of the film as the film is formed during extrusion and/or coating.

As used herein, the phrase “transverse direction”, herein abbreviated “TD”, refers to a direction across the film, perpendicular to the machine or longitudinal direction.

As used herein, the phrase “free shrink” refers to the percent dimensional change in a 10 cm×10 cm specimen of film, when subjected to selected heat, as measured by ASTM D 2732, as known to those of skill in the art.

Although the films used in the patch bag according to the present invention can be monolayer films or multilayer films, the patch bag comprises at least two films laminated together. Preferably, the patch bag is comprised of films which together comprise a total of from 2 to 20 layers; more preferably, from 2 to 12 layers; and still more preferably, from 4 to 9 layers.

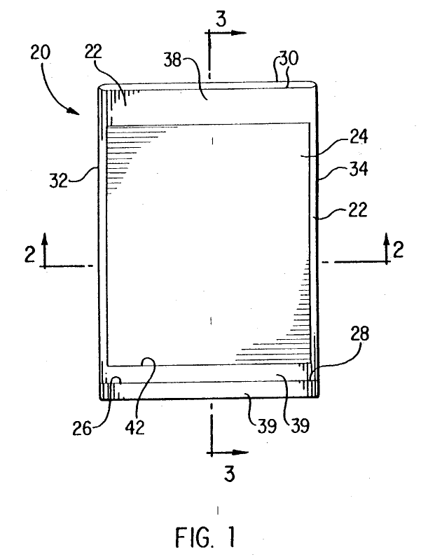

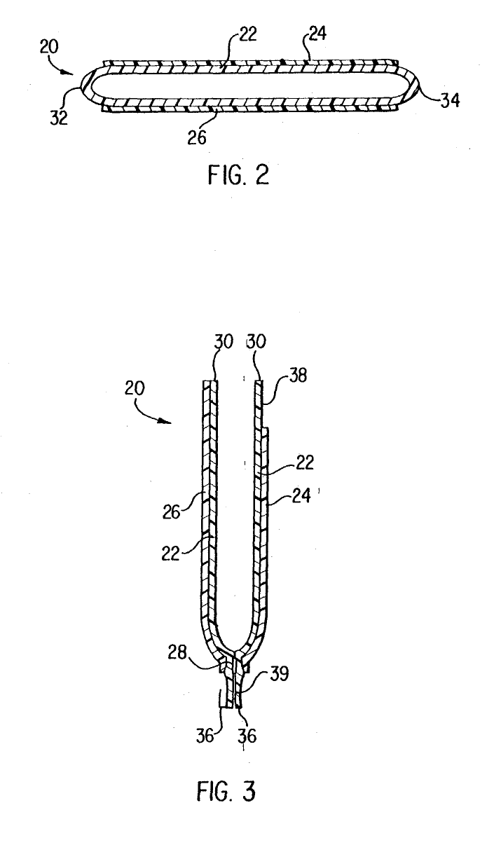

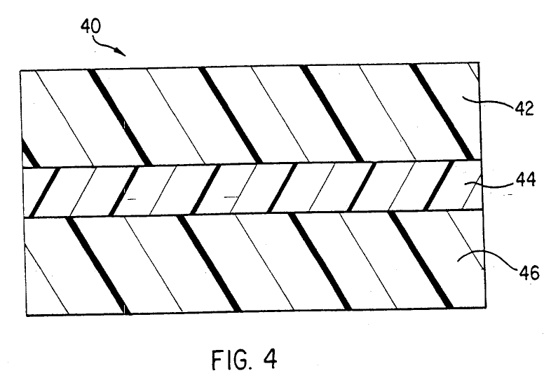

FIG. 1 illustrates a preferred end-seal patch bag 20 according to the present invention, in a lay-flat configuration; FIG. 2 illustrates a transverse cross-sectional view of patch bag 20 taken through section 2-2 of FIG. 1; and, FIG. 3 illustrates a longitudinal cross-sectional view of patch bag 20 taken through section 3-3 of FIG. 1. Viewing FIGS. 1, 2, and 3 together, patch bag 20 comprises bag 22, discontinuous patch 24, and continuous patch 26. Patch bag 20 has end-seal 28, bag top edge 30, bag first side edge 32, bag second side edge 34, and bag bottom edge 36.

As illustrated in FIG. 2, discontinuous patch 24 is adhered to a first lay-flat side of patch bag 20, and continuous patch 26 is adhered to a second lay-flat side of patch bag 20. Although both discontinuous patch 24 and continuous patch 26 could extend to or even past bag lay-flat side edges 32 and 34, as illustrated in FIGS. 1 and 2 neither discontinuous patch 24 nor continuous patch 26 extends to either first side edge 32 or second side edge 34. Furthermore, discontinuous patch 24 stops short of top edge 30, thereby leaving bag region 38 available for the application of heat to form a top heat seal after a product is placed in patch bag 20. Discontinuous patch 24 stops short of bottom end-seal 28 as discontinuous patch 24 is preferably adhered to the tubing from which bag 22 is thereafter formed, i.e., patch 24 is adhered to the tubing before the formation of bottom end-seal 28. In this manner, bottom end-seal 28 can be formed without having to apply heat through patch material, as the heat can be applied to the first lay-flat side of patch bag 20, rather than through continuous patch 26 adhered to the second lay-flat side of bag 22.

As illustrated in the longitudinal cross-sectional view of FIG. 3, continuous patch 26 extends from patch bag top edge 30 through patch bag bottom edge 36. Continuous patch 26 provides patch coverage down to and over bottom end-seal 28. In this manner, continuous patch 26 enhances the degree of patch coverage of the second lay-flat side of bag 22. Furthermore, in the production of patch bag 20, continuous patch 26 does not have to be cut into pieces and thereafter carefully indexed onto tubing in a manner so that it corresponds with the placement of discontinuous patch 24. Rather, continuous patch 26 can be continuously laminated onto the second lay-flat side of the tubing, with intermittent patches 24 being adhered to the first lay-flat side thereof, followed by application of a transverse heat-seal and transverse cuttings, to result in patch bag 20.

That portion of bag 22 to which discontinuous patch 24 is adhered is “covered”, i.e, protected, by front patch 24. Upper end region 38 and lower end region 39 of the first lay-flat side of bag 22 are not covered by front patch 24, in order that a stronger bottom end seal 28 can be made, and in order that a stronger top end seal (not illustrated) can also be made after product is inserted into patch bag 20.

In general, the multilayer film(s) used in the present invention can have any total thickness desired, so long as the film provides the desired properties for the particular packaging operation in which the film is used, e.g. abuse-resistance (especially puncture-resistance), modulus, seal strength, optics, etc. Preferably, the film stock from which the patches are cut has a total thickness of from about 2 to 8 mils; more preferably, from about 3 to 6 mils. Preferably, the stock film from which the bag is formed has a total thickness of from about 1.5 to 5 mils; more preferably, about 2.5 mils. Preferably the stock film from which the bag is formed is a multilayer film having from 3 to 7 layers; more preferably, 4 layers.

FIG. 4 illustrates a cross-sectional view of preferred multilayer film 40 for use as the stock material from which patches 24 and 26 are formed. Multilayer film 40 preferably has a physical structure, in terms of number of layers, layer thickness, and layer arrangement and orientation in the patch bag, and a chemical composition in terms of the various polymers, etc. present in each of the layers, as set forth in Table 1, below.

TABLE 1

| | | Chemical | Layer |
|---|---|---|---|
| Layer | | Composition | Thickness |
| Designation | Layer Function | of Layer | (mils) |
| 42 | outside layer & | 87% LLDPE #1; 10% | 2.0 |
| | puncture | EVA #1; 3% antiblock | |
| | resistant layer | masterbatch #1 | |
| 44 | tie layer | EVA #2 | 0.7 |
| 46 | inside layer & | 87% LLDPE #1; 10% | 2.0 |
| | puncture | EVA #1; 3% antiblock | |
| | resistant layer | masterbatch #1 | |

LLDPE #1 is DOWLEX 2045 (TM) linear low density polyethylene, and can be obtained from the Dow Chemical Company of Midland, Mich. EVA #1 is ELVAX 3128 (TM) ethylene/vinyl acetate copolymer having a 9% vinyl acetate content, which can be obtained from E. I. DuPont de Nemours, of Wilmington, Del. EVA #2 is ELVAX 3175 GC (TM) ethylene/vinyl acetate copolymer having a 28% vinyl acetate content, and can be obtained from E. I. DuPont de Nemours, of Wilmington, Del. Antiblock masterbatch #1 is to be used in either of two different grades. The first grade, a clear masterbatch, is a masterbatch known as 10,075 ACP SYLOID CONCENTRATE (TM), which can be obtained from Technor Apex Co. of Pautucket, Rhode Island. The second grade, a creme colored masterbatch, is a masterbatch known as EPC 9621 C CREAM COLOR SYLOID CONCENTRATE (TM), also obtainable from Technor Apex Co. of Pautucket, R.I. The primary difference between these two masterbatches is that of color, which is both aesthetic, and potentially functional in that photosensor alignment means for accurate registration of the patches on the bags can utilize the coloration in the patch for detection of the location of the patch.

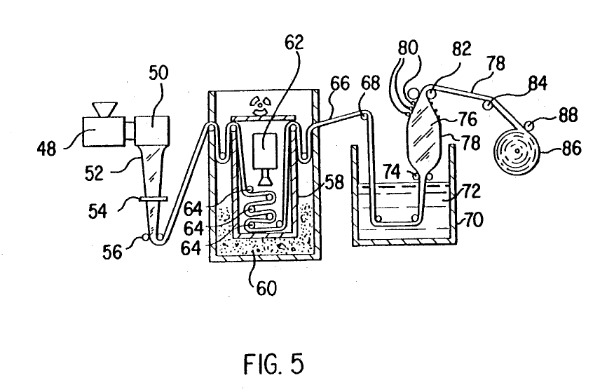

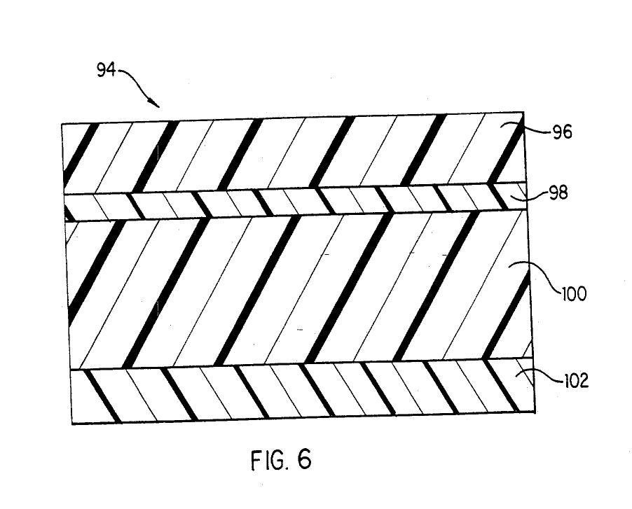

FIG. 5 illustrates a schematic of a preferred process for producing the multilayer film 40 illustrated in FIG. 4. In the process illustrated in FIG. 5, solid polymer beads (not illustrated) are fed to a plurality of extruders 48 (for simplicity, only one extruder is illustrated). Inside extruders 48, the polymer beads are forwarded, melted, and degassed, following which the resulting bubble-free melt is forwarded into die head 50, and extruded through annular die, resulting in tubing 52 which is 5-40 mils thick, more preferably 20-30 mils thick, still more preferably, about 25 mils thick. After cooling or quenching by water spray from cooling ring 54, tubing 52 is collapsed by pinch rolls 56, and is thereafter fed through irradiation vault 58 surrounded by shielding 60, where tubing 52 is irradiated with high energy electrons (i.e., ionizing radiation) from iron core transformer accelerator 62. Tubing 52 is guided through irradiation vault 58 on rolls 64. Preferably, the irradiation of tubing 52 is at a level of about 7 MR.

After irradiation, irradiated tubing 66 is directed over guide roll 68, after which irradiated tubing 66 passes into hot water bath tank 70 containing hot water 72. The now collapsed irradiated tubing 66 is submersed in hot water 72 for a retention time of at least about 5 seconds, i.e., for a time period in order to bring irradiated tubing 66 up to the desired temperature, following which supplemental heating means (not illustrated) including a plurality of steam rolls around which irradiated tubing 66 is partially wound, and optional hot air blowers, elevate the temperature of irradiated tubing 66 to a desired orientation temperature of from about 240° F.-250° F. Thereafter, irradiated film 66 is directed through nip rolls 74, and bubble 76 is blown, thereby transversely stretching irradiated tubing 66. Furthermore, while being blown, i.e., transversely stretched, irradiated film 66 is drawn (i.e., in the longitudinal direction) between nip rolls 74 and nip rolls 82, as nip rolls 82 have a higher surface speed than the surface speed of nip rolls 74. As a result of the transverse stretching and longitudinal drawing, irradiated, biaxially-oriented, blown tubing film 78 is produced, this blown tubing preferably having been both stretched at a ratio of from about 1:1.5-1:6, and drawn at a ratio of from about 1:1.5-1:6. More preferably, the stretching and drawing are each performed at a ratio of from about 1:2-1:4. The result is a biaxial orientation of from about 1:2.25-1:36, more preferably, 1:4-1:16.

While bubble 76 is maintained between pinch rolls 74 and 82, blown tubing 78 is callapsed by rolls 80, and thereafter conveyed through pinch rolls 82 and across guide roll 84, and then rolled onto wind-up roll 86. Idler roll 88 assures a good wind-up.

FIG. 6 illustrates a cross-sectional view of preferred multilayer film 94 for use as the tubing film stock from which bag 22 is formed. Multilayer film 94 has a physical structure, in terms of number of layers, layer thickness, and layer arrangement and orientation in the patch bag, and a chemical composition in terms of the various polymers, etc. present in each of the layers, as set forth in Table 2, below.

TABLE 2

| | | | Layer |
|---|---|---|---|
| Layer | | | Thickness |
| Designation | Layer Function | Layer Composition | (mils) |
| 96 | outside layer & | EVA #1 | 0.56 |
| | abuse layer | | |
| 98 | O₂-barrier | 96% VDC/MA #1; | 0.2 |
| | layer | 2% epoxidized soybean oil; | |
| | | 2% bu-A/MA/bu-MA | |
| | | terpolymer | |
| 100 | puncture-resistant | 80% LLDPE #1 | 1.25 |
| | layer | 20% EBA #1 | |
| | | (an irradiated layer) | |
| 102 | sealant layer & | EVA #1 | 0.33 |
| | inside layer | (an irradiated layer) | |

EVA #1 is the same ethylene/vinyl acetate copolymer described above. VDC/MA #1 is SARAN MA-134 (TM) vinylidene chloride/methyl acrylate copolymer, and can be obtained from the Dow Chemical Company. The epoxidized soybean oil is PLAS-CHEK 775 (TM) epoxidized soybean oil, obtainable from the Bedford Chemical Division of Ferro Corporation, of Walton Hills, Ohio. Bu-A/MA/bu-MA terpolymer is METABLEN L-1000 (TM) butyl acrylate/methyl methacrylate/butyl methacrylate terpolymer, and can be obtained from Elf Atochem North America, Inc., of 2000 Market Street, Philadelphia, Pa. 19103. EBA #1 is EA 705-009 (TM) ethylene/butyl acrylate copolymer containing 5% butyl acrylate, obtainable from the Quantum Chemical Company of Cincinnati, Ohio. Alternatively, EBA #1 can be EA 719-009 (TM) ethylene/butyl acrylate copolymer, having a butyl acrylate content of 18.5%; also obtainable from Quantum Chemical Company.

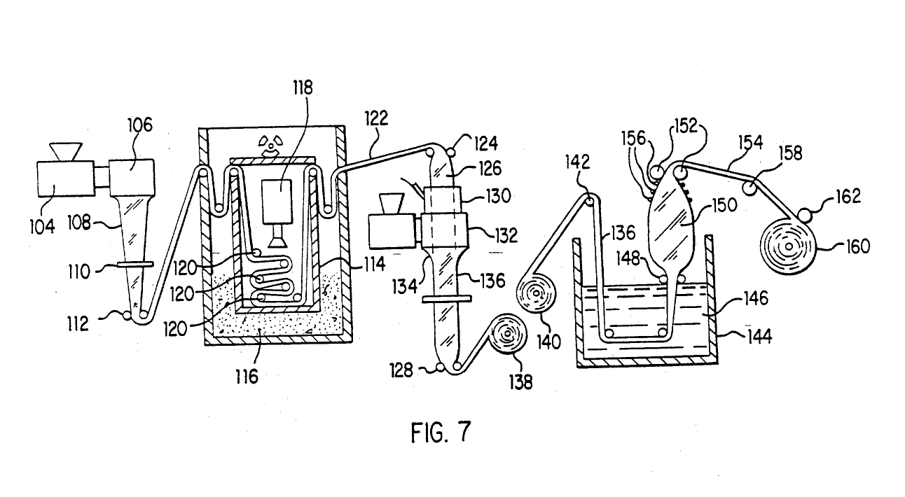

FIG. 7 illustrates a schematic of a preferred process for producing the multilayer film 94 illustrated in FIG. 6. In the process illustrated in FIG. 7, solid polymer beads (not illustrated) are fed to a plurality of extruders 104 (for simplicity, only one extruder is illustrated). Inside extruders 104, the polymer beads are forwarded, melted, and degassed, following which the resulting bubble-free melt is forwarded into die head 106, and is extruded through an annular die, resulting in tubing 108, which is preferably from about 10 to 30 mils thick, more preferably from about 15 to 25 mils thick. After cooling or quenching by water spray from cooling ring 110, tubing 108 is collapsed by pinch rolls 112, and is thereafter fed through irradiation vault 114 surrounded by shielding 116, where tubing 108 is irradiated with high energy electrons (i.e., ionizing radiation) from iron core transformer accelerator 118. Tubing 108 is guided through irradiation vault 114 on rolls 120. Preferably, tubing 108 is irradiated to a level of about 4.5 MR.

After irradiation, irradiated tubing 122 is directed through pre-coating nip rolls 124, following which tubing 122 is slightly inflated, resulting in trapped bubble 126. However, at trapped bubble 126, tubing 122 is not significantly drawn longitudinally, as the surface speed of post-coating nip rolls 128 is about the same as that of pre-coating nip rolls 124. Furthermore, irradiated tubing 122 is inflated only enough to provide a substantially circular tubing without significant transverse orientation, i.e., without stretching.

Slightly inflated, irradiated tubing 122 is passed through vacuum chamber 130, and thereafter forwarded through coating die 132. Second tubular film 134 is melt-extruded from coating die 132 and coated onto slightly inflated, irradiated tube 122, to form two-ply tubular film 136. Second tubular film 134 preferably comprises an O₂ barrier layer (preferably comprising polyvinylidene chloride), which does not pass through the ionizing radiation. Further details of the above-described coating step are generally as set forth in U.S. Pat. No. 4,278,738, to BRAX et. al., which is hereby incorporated by reference thereto, in its entirety.

After irradiation and coating, two-ply tubing film 136 is wound up onto windup roll 138. Thereafter, windup roll 138 is removed and installed as unwind roll 140, on a second stage in the process of making the tubing film as ultimately desired. Two-ply tubular film 136, from unwind roll 140, is unwound and passed over guide roll 142, after which two-ply tubular film 136 passes into hot water bath tank 144 containing hot water 146. The now collapsed, irradiated, coated tubular film 136 is submersed in hot water 146 (having a temperature of about 210° F.) for a retention time of at least about 5 seconds, i.e., for a time period in order to bring the film up to the desired temperature for biaxial orientation. Thereafter, irradiated tubular film 136 is directed through nip rolls 148, and bubble 150 is blown, thereby transversely stretching tubular film 136. Furthermore, while being blown, i.e., transversely stretched, nip rolls 152 draw tubular film 136 in the longitudinal direction, as nip rolls 152 have a surface speed higher than the surface speed of nip rolls 148. As a result of the transverse stretching and longitudinal drawing, irradiated, coated biaxially-oriented blown tubing film 154 is produced, this blown tubing preferably having been both stretched in a ratio of from about 1:1.5-1:6, and drawn in a ratio of from about 1:1.5-1:6. More preferably, the stretching and drawing are each performed a ratio of from about 1:2-1:4. The result is a biaxial orientation of from about 1:2.25-1:36, more preferably, 1:4-1:16. While bubble 150 is maintained between nip rolls 148 and 152, blown tubing 154 is collapsed by rollers 156, and thereafter conveyed through nip rolls 152 and across guide roll 158, and then rolled onto wind-up roll 160. Idler roll 162 assures a good wind-up. The polymer components used to fabricate multilayer films according to the present invention may also contain appropriate amounts of other additives normally included in such compositions. These include slip agents such as talc, antioxidants, fillers, dyes, pigments and dyes, radiation stabilizers, antistatic agents, elastomers, and the like additives known to those of skill in the art of packaging films.

The multilayer films used to make the patch bag of the present invention are preferably irradiated to induce crosslinking, as well as corona treated to roughen the surface of the films which are to be adhered to one another. In the irradiation process, the film is subjected to an energetic radiation treatment, such as corona discharge, plasma, flame, ultraviolet, X-ray, gamma ray, beta ray, and high energy electron treatment, which induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking the polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. A suitable radiation dosage of high energy electrons is in the range of up to about 16-166 kGy, more preferably about 44-139 kGy, and still more preferably, 80-120 kGy. Preferably, irradiation is carried out by an electron accelerator and the dosage level is determined by standard dosimetry methods.

Other accelerators such as a Vander Graff or resonating transformer may be used. The radiation is not limited to electrons from an accelerator since any ionizing radiation may be used. The unit of ionizing radiation generally used is the rad, hereinafter referred to as “RAD”, which is defined as the amount of radiation which will result in the absorption of 100 ergs of energy per gram of irradiated material. The megarad, hereinafter referred to as “MR”, is one million (10⁶) RAD. The ionizing radiation crosslinks the polymers in the film. Preferably, the film is irradiated at a level of from 2-15 MR, more preferably 2-10 MR, still more preferably, about 7 MR. As can be seen from the descriptions of preferred films for use in the present invention, the most preferred amount of radiation is dependent upon the film and its end use.

As used herein, the phrases “corona treatment” and “corona discharge treatment” refer to subjecting the surfaces of thermoplastic materials, such as polyolefins, to corona discharge, i.e., the ionization of a gas such as air in close proximity to a film surface, the ionization being initiated by a high voltage passed through a nearby electrode, causing oxidation and other changes to the film surface, such as surface roughness. Corona treatment of polymeric materials, disclosed in U.S. Pat. No. 4,120,716 to BONET issued Oct. 17, 1978 (hereby incorporated in its entirety by reference thereto), discloses corona treatment as oxidizing the surface of the polyethylene, thereby improving its adherence characteristics. U.S. Pat. No. 4,879,430, to HOFFMAN, also hereby incorporated in its entirety by reference thereto, discloses the use of corona discharge for the treatment of plastic webs for use in meat cook-in packaging, with the corona treatment of the inside surface of the web increasing the adhesion of the web to the proteinaceous material. Although corona treatment is a preferred treatment of the multilayer films used to make the patch bag of the present invention, plasma treatment of the film may also be used.

The patch bag illustrated in FIGS. 1, 2, and 3 has patches which do not extend to the first and second side edges of the lay-flat bag. Although such a patch bag has areas left unprotected, it is easier to produce than a patch bag having the patches extending to or even past one or more of the lay-flat side edges. By having the patches narrower than the bag, misalignment and exposed glue problems are avoided. However, this leaves uncovered regions along the side edges of the lay-flat bag. Although for some end uses the uncovered regions do not present any substantial bone puncture problems, for certain cuts of meat, such as bone-in pork loins, the uncovered regions along the bag side edges is less than optimal. For such end uses, it is desirable to provide patches which overhang the side edges of the bag. Patch bags comprising overhanging bonded patches are disclosed in copending U.S. patent application Ser. No. 08/268,087, in the name of H. W. Stockley et al., filed Jun. 28, 1994, entitled “PATCH BAG HAVING OVERHANGING BONDED PATCHES”, the entirety of which is hereby incorporated by reference thereto. Such overhanging patches are, of course, useful in conjunction with the patch bag according to the present invention.

In addition, the patch bag illustrated in FIGS. 1, 2, and 3 has only one bottom end seal, which is spaced a short distance down from a bottom edge of the discontinuous patch. Although the area between the bottom edge of the discontinuous patch and the heat seal is left unprotected, for reasons set forth above, such a bag is easier to produce than a patch bag having the discontinuous patch extending to or even past the heat seal. However, one or more supplemental heat seals can be utilized in order to keep the product from puncturing the uncovered area between the heat seal and the bottom edge of the discontinuous patch. Such supplemental seals are disclosed in copending U.S. patent application Ser. No. 08/278,367, in the name of S. A. Brady et al., filed Jul. 21, 1994, entitled “PATCH BAG HAVING SUPPLEMENTAL SEAL”, the entirety of which is hereby incorporated by reference thereto. Such supplemental seals are, of course, useful in conjunction with the patch bag according to the present invention.

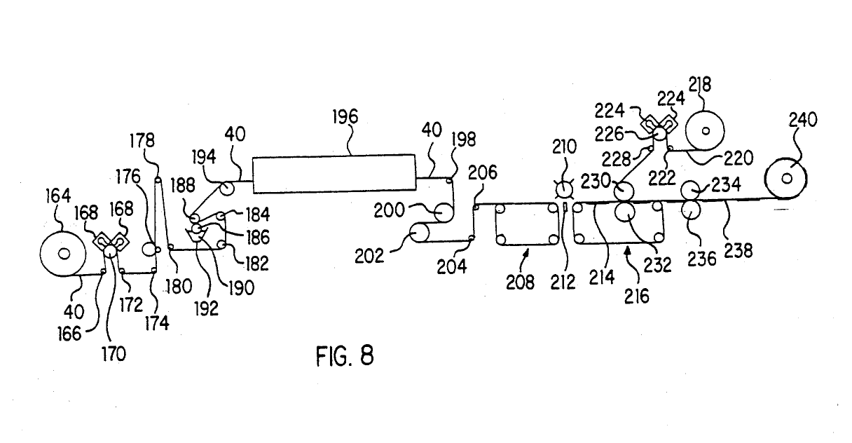

In the bag-making process, if an end-seal patch bag is the desired product, the tubing having the first and second patches adhered thereto is sealed and cut so that an end-seal bag is produced. FIG. 8 illustrates a schematic representation of a preferred process for manufacturing a patch bag according to the present invention (e.g., a patch bag as illustrated in FIGS. 1, 2, and 3) from the films as illustrated in FIGS. 4 and 6, which are prepared according to processes as illustrated in FIGS. 5 and 7, respectively.

In FIG. 8, patch film roll 164 supplies patch film 40. Patch film 40 is directed, by idler roll 166, to corona treatment devices 168 which subject the upper surface of patch film 40 to corona treatment as patch film 40 passes over corona treatment roll 170.

After corona treatment, patch film 40 is directed, by idler rolls 172 and 174, into (optional) printing roll 176.

Patch film 40 is thereafter directed over idler rolls 178, 180, 182, and 184, after which patch film 40 is passed between a small gap (i.e., a gap wide enough to accommodate patch film 40 passing therethrough while receiving an amount of adhesive which corresponds with a dry coating (i.e., weight after drying, of about 45 milligrams per 10 square inches of patch film) between adhesive application roll 186 and adhesive metering roll 188. Adhesive application roll 186 is partially immersed in adhesive 190 supplied to trough 192. As adhesive roll 186 rotates counter-clockwise, adhesive 190, picked up by the immersed surface of adhesive roll 186, moves upward, contacts, and is metered onto, the full width of one side of patch film 40, moving in the same direction as the surface of adhesive roll 186. [Examples of suitable types of adhesives include thermoplastic acrylic emulsions, solvent based adhesives and high solids adhesives, ultraviolet-cured adhesive, and electron-beam cured adhesive, as known to those of skill in the art. The presently preferred adhesive is a thermoplastic acrylic emulsion known as RHOPLEX N619 (TM) thermoplastic acrylic emulsion, obtained from the Rohm & Haas Company, at Dominion Plaza Suite 545, 17304 Preston Rd., Dallas, Tex. 75252, Rohm & Haas having headquarters at 7th floor, Independence Mall West, Philadelphia, Penn. 19105.] Patch film 40 thereafter passes so far around adhesive metering roll 188 (rotating clockwise) that the adhesive-coated side of patch film 40 is in an orientation wherein the adhesive is on the top surface of patch film 40, as adhesive-coated patch film 40 moves between adhesive metering roll 188 and drying oven entrance idler roll 194.

Thereafter, adhesive-coated patch film 40 is directed over drying oven entrance idler roll 194, and passed through oven 196 within which adhesive coated patch film 40 is dried to a degree that the adhesive on patch film 40 becomes tacky. Upon exiting oven 196, patch film 40 is directed partially around oven-exit idler roll 198, following which patch film 40 is cooled on chill rolls 200 and 202, each of which has a surface temperature of about 40-45° F., and a diameter of about 12 inches. The cooling of patch film 40 is carried out in order to stabilize patch film 40 from further shrinkage.

Thereafter, patch film 40 is directed, by idler rolls 204 and 206, onto a belt of pre-cutting vacuum conveyor assembly 208, and thereafter forwarded to a rotary scissors-type knife having upper rotary blade assembly 210 and lower blade 212, the knife cutting across the width of patch film 40 in order to form patches 214. Patches 214 are forwarded and held on top of a belt of post-cutting vacuum conveyor assembly 216. While patches 214 are held on the belt of post-cutting vacuum conveyor assembly 216, tubing-supply roll 218 supplies biaxially oriented, lay-flat film tubing 220, which is directed, by idler roll 222, to corona treatment devices 224 which subject the upper surface of lay-flat tubing film 220 to corona treatment as lay-flat tubing film 220 passes over corona treatment roll 226. After corona treatment, lay-flat tubing film 220 is directed, by idler roll 228, partially around the surface of upper prelamination nip roll 230, and through the nip between upper prelaminating nip roll 230 and lower prelaminating nip roll 232, the pre-laminating nip rolls being above and below the post-cutting vacuum conveyor belt. Prelaminating nip rolls 230 and 232 position patches 214 onto the now lower, corona-treated outside surface of lay-flat film tubing 220. After passing through the nip between prelaminating nip rolls 230 and 232, lay-flat tubing 220, having patches 214 laminated intermittently thereon, exits off the downstream end of the post-cutting vacuum conveyor assembly 216, and is directed through the nip between upper laminating nip roll 234 and lower laminating nip roll 236, these rolls exerting pressure (about 75 psi) in order to secure patches 214 to lay-flat tubing 220, to result in patch-laminated lay-flat tubing 238. Thereafter, patch-laminated lay-flat tubing 238 is wound up to form rewind roll 240, with rewind roll 240 having the laminated patches thereon oriented towards the outer-facing surface of rewind roll 240.

In a subsequent process not separately illustrated, rewind roll 240 is removed from its winder and is positioned in the place of tubing supply roll 218, and the process of FIG. 7, described immediately above, is repeated, except that patch film 40, which is not cut into patches, is continuously laminated to the other lay-flat side of discontinuous patch-laminated lay-flat tubing 238.

Throughout the process described above, patches 214 can have a width less than, equal to, or greater than, the width of lay-flat tubing film 40, so that the patches respectively: leave uncovered regions along the sides of the bag, go to the edge of the lay-flat tubing, or, overhang the side edges of lay-flat tubing film 40.

Once both the discontinuous patches and the continuous patch have been applied to lay-flat tubing film 172, the resulting patch-laminated tubing is directed into a bag-making machine, in a process not illustrated. The bag-making machine converts the tubing (having patches thereon) to a plurality of patch bags, by cutting and sealing the tubing at the appropriate locations.

In general, heat seals can be made using a hot bar (heat seal) or a nichrome wire fixed to a chilled metal bar (impulse seal), as is known to those of skill in the art, or any other sealing means known to those of skill in the art, such as ultrasonic radiation, radio frequency radiation, and laser. The preferred sealing means is an impulse sealer. Films which are predominantly polyethylene are generally sealed using impulse sealing or hot bar sealing. Both linear and shaped seals can be formed, as is known to those of skill in the art. In general, sealing and cutting of tubing to produce bags is disclosed in U.S. Pat. No. 3,552,090, U.S. Pat. No. 3,383,746, and U.S. Serial No. 844,883, filed Jul. 25, 1969, to OWEN, each of these two U.S. Patents as well as the U.S. Patent application, hereby being incorporated by reference thereto, in their entireties. As can be readily recognized by those of skill in the art, a patch bag according to the present invention can be produced as an end-seal bag or a side seal bag.

Although in general the bag according to the present invention can be used in the packaging of any product, the bag of the present invention is especially advantageous for the packaging of food products, especially fresh meat products, even more particularly, bone-in meat products. Among the meat products which can be packaged in the films and packages according to the present invention are poultry, pork, beef, lamb, goat, horse, and fish.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

What is claimed is:

1. An patch bag comprising a bag and a first patch adhered to a first lay-flat side of the bag, wherein the first patch has a length of at least the length of the bag, and wherein no portion of a second lay-flat side of the bag is adhered to a second patch.

2. The patch bag according to claim 1, wherein the bag comprises a first heat shrinkable film and the first patch comprises a second heat-shrinkable film.

3. The patch bag according to claim 2, wherein the bag is an end seal bag.

4. The patch bag according to claim 3, wherein:
(A) the first heat shrinkable film comprises:
an outside abuse layer comprising at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer;
a core O₂ barrier layer of the bag comprising at least one member selected from the group consisting of ethylene/vinyl alcohol copolymer, polyvinyl chloride, polyvinylidene chloride, polyamide, polyester, polyacrylonitrile;
an inside sealant layer comprising at least one member selected from the group consisting of thermoplastic polyolefin, thermoplastic polyamide, thermoplastic polyester, and thermoplastic polyvinyl chloride; and
(B) the second heat shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer.

5. The patch bag according to claim 4, wherein the second heat-shrinkable film is biaxially oriented and comprises linear low density polyethylene and ethylene/vinyl acetate copolymer.

6. A patch bag comprising a bag, a first patch, and a second patch, wherein:
(A) the first patch is adhered to a first lay-flat side of the bag, the first patch having a length of at least the length of the bag;
(B) the second patch is adhered to a second lay-flat side of the bag, the second patch having a length less than the length of the bag; and
(C) the patch bag further comprises a seal, wherein at least, a portion of the seal is in a region not covered by the second patch.

7. The patch bag according to claim 6, wherein the entire seal is in a region not covered by the second patch.

8. The patch bag according to claim 7, wherein the patch bag is a side-seal patch bag.

9. The patch bag according to claim 8, wherein:
the first patch extends below a bottom edge of the bag, the first patch having a first overhang region over the end of the bag;
the second patch also extending below the bottom edge of the bag, the second patch having a second overhang region over the end of the bag; and
the first overhang region adheres to the second overhang region.

10. The patch bag according to claim 7, wherein the bag comprises a first heat shrinkable film, the first patch comprises a second heat-shrinkable film, and the second patch comprises a third heat-shrinkable film.

11. The patch bag according to claim 8, wherein the a first heat shrinkable film is a multilayer film, the second heat-shrinkable film is a multilayer film, and the third heat-shrinkable film is a multilayer film.

12. The patch bag according to claim 11, wherein the first heat-shrinkable film comprises:
an outside abuse layer comprising at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer;
a core O₂ barrier layer of the bag comprising at least one member selected from the group consisting of ethylene/vinyl alcohol copolymer, polyvinyl chloride, polyvinylidene chloride, polyamide, polyester, polyacrylonitrile;
an inside sealant layer comprising at least one member selected from the group consisting of thermoplastic polyolefin, thermoplastic polyamide, thermoplastic polyester, and thermoplastic polyvinyl chloride.

13. The patch bag according to claim 12, wherein:
the second biaxially-oriented, heat-shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer; and
the third biaxially-oriented, heat-shrinkable film comprises at least one member selected from the group consisting of ethylene/alpha-olefin copolymer having a density of from about 0.85 to 0.95, propylene/ethylene copolymer, polyamide, ethylene/vinyl acetate copolymer, ethylene/methyl acrylate copolymer, and ethylene/butyl acrylate copolymer.

14. The patch bag according to claim 13, wherein:
the second biaxially-oriented, heat-shrinkable film comprises linear low density polyethylene and ethylene/vinyl acetate copolymer; and
the third biaxially-oriented, heat-shrinkable film comprises linear low density polyethylene and ethylene/vinyl acetate copolymer.

15. The patch bag according to claim 8, wherein the patch bag is an end-seal patch bag.

16. The patch bag according to claim 15, wherein:
the first patch has a width greater than a lay-flat width of the tubing, the first patch having a first overhang region over a first side edge of the bag, and a second overhang region over a second side edge of the bag;
the second patch also has a width greater than a lay-flat width of the tubing, the second patch having a third overhang region over the first side edge of the bag, and a fourth overhang region over the second side edge of the bag; and
the first overhang region adheres to the third overhang region, and the second overhang region adheres to the fourth overhang region.

17. The patch bag according to claim 16, wherein the first patch has a length equal to a length of the bag.

18. The patch bag according to claim 17, wherein the second patch does not extend to a top of the bag.

19. A packaged product, comprising:
(A) a package comprising a patch bag comprising a bag, a first patch, and a second patch, wherein:
(i) the first patch is adhered to a first lay-flat side of the bag, the first patch having a length of at least the length of the bag;
(ii) the second patch is adhered to a second lay-flat side of the bag, the second patch having a length less than the length of the bag; and
(iii) the patch bag further comprises a seal, wherein the seal is in a region not covered by the second patch; and
(B) a meat product in said package, the meat product comprising bone.

20. The packaged product according to claim 19, wherein the meat product comprises at least one member selected from the group consisting of ham, sparerib, picnic, back rib, short loin, short rib, whole turkey, pork loin.

21. The packaged product according to claim 20, wherein the meat product comprises two bone-in pork loins.
